(19) United States
(12) Patent Application Publication
(10) Pub. No.: US 2006/0266866 A1
(43) Pub. Date: Nov. 30, 2006

(54) Drive for a belt tensioner

(75) Inventors: Peter Schmidt, Ostfildern (DE); Gerhard Malbrich, Gschwend (DE); Patrick Foussier, Buehl (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive GmbH

(21) Appl. No.: 11/438,451

(22) Filed: May 22, 2006

(30) Foreign Application Priority Data
May 25, 2005 (DE) 10 2005 024 115.8

(51) Int. Cl. B60R 22/46

(52) U.S. Cl. 242/374

(57) ABSTRACT

A drive (10) for a belt tensioner includes a housing (24), a piston (20) that is movably accommodated in the housing (24), and a rack (16) having a toothing (14). The rack (16) is arranged outside the housing (24) and has a guide section (18). The guide section (18) is coordinated with a counter guide section that is arranged outside the housing (24).

### TECHNICAL FIELD

The present invention relates to a drive for a belt tensioner, in particular to a drive comprising a housing, a piston that is movably accommodated in the housing, and a rack having a toothing.

### BACKGROUND OF THE INVENTION

In order to remove so-called belt slack from a safety belt system, a belt tensioner serves to act in the wind-up direction of the safety belt upon a belt reel of a belt retractor that is assigned to the belt tensioner. Belt tensioners that have a pyrotechnic drive are widely used, in which a pressurized gas cartridge, arranged in the housing, upon activation releases a large quantity of gas under pressure. This gas acts upon the piston, which as a result is moved within the housing, the rack being moved along with the piston. A pinion that engages in the rack transforms the linear motion into a rotational motion and transmits this to the belt reel of the belt retractor.

If the function of the piston is expanded from the pure transmission of thrust to include the accommodation and guidance of the rack, e.g., by molding guide sections onto the piston, it is possible that, during the operation of the belt tensioner drive, high mechanical stresses may arise, which must be taken into account in designing the drive (in selecting materials and dimensioning the components).

It is an object of the present invention to provide a belt tensioner drive that features reduced stress on components.

### BRIEF DESCRIPTION OF THE INVENTION

According to the invention, a drive for a belt tensioner cpmprises a housing, a piston that is movably accommodated in the housing, and a rack having a toothing. The rack is arranged outside the housing and has a guide section. The guide section is coordinated with a counter guide section that is arranged outside the housing. In this way, the piston is not responsible for the accommodation and guidance of the rack, since according to the present invention the rack itself essentially takes on this function. This has a positive effect on the stress of the participating components, because no increased tensions arise due to rigid connecting points between the actual piston and the guide sections that are molded onto it.

In one preferred embodiment of the present invention, the counter guide section is configured on the exterior wall of the housing. By directly supporting the rack on the exterior wall of the housing, the present invention makes possible a compact design of the belt tensioner drive.

The guide section is preferably profiled.

The piston and the rack may be connected to each other either rigidly or via a joint, preferably a swivel joint. The connection via a swivel joint is more resistant to stress due to the additional degree of freedom that it provides.

### BRIEF DESCRIPTION OF THE DRAWINGS

FIG. 1 depicts a section of a belt tensioner drive according to a first embodiment of the present invention;

FIG. 2 depicts a perspective view of the piston and the rack of the belt tensioner drive from FIG. 1;

FIG. 3 depicts a section of the belt tensioner drive from FIG. 1 in the plane III-III;

FIG. 4 depicts a section of the belt tensioner drive from FIG. 1 in the plane IV-IV;

FIG. 5 depicts a partially sectioned side view of a belt tensioner including a drive according to a second embodiment of the present invention; and

FIG. 6 depicts a section of the belt tensioner drive from FIG. 5 in the plane A-A.

### DETAILED DESCRIPTION OF THE PREFERRED EMBODIMENTS

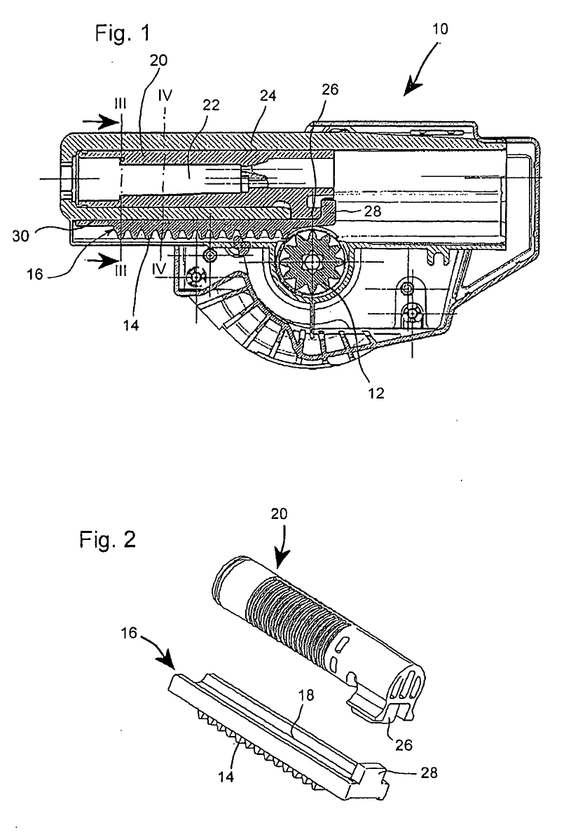

FIG. 1 shows a drive 10 for a belt tensioner that in an emergency functions to drive a belt reel of a belt retractor in the wind-up direction of the belt. The connection between the drive 10 and the belt reel is accomplished via a pinion 12, which is connected to the belt reel for joint rotation therewith or by a gearing and into which a toothing 14 of a rack 16 of the drive 10 engages. The rack 16, which is shown separately in FIG. 2, in addition to the toothing 14 has a profiled guide section 18 (see FIG. 2).

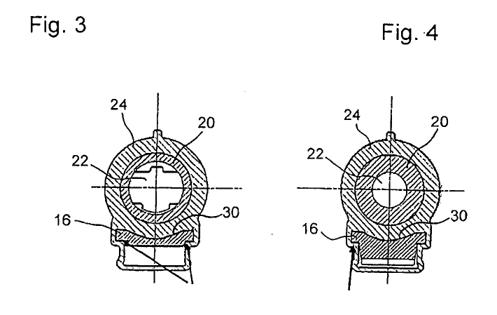

The drive 10 also includes a piston 20, which has a pressure space 22 and is movably accommodated in the interior of a housing 24. The piston 20, which has a circular cross section (see FIGS. 3 and 4), is arranged in a receptacle of the housing 24, which also has a circular cross section, in addition to being closed in the circumferential direction. In the initial position of the piston 20, shown in FIG. 1, the pinion 12 can rotate freely.

As can be seen in FIG. 1, the rack 16 is designed to be spatially separate from the piston 20. However, the two parts 16, 20 are connected to each other, the connection being realized either rigidly or via a joint, preferably via a swivel joint. The linear transmission of force from the piston 20 to the rack 16 is accomplished by a radial extension 26 of the piston 20, which engages a limit stop 28 of the rack 16. The side of the rack 16 that is opposite the toothing 14 rests on an exterior wall section 30 of the housing 24, which functions as a counter guide section for the rack 16. From FIGS. 3 and 4, it can be seen that the shape of the exterior wall section 30 is coordinated with the guide section 18 of the rack 16. Therefore, a secure support is provided (see arrows in FIGS. 3 and 4), and the rack 16 is securely guided during the linear motion of the piston 20.

The drive 10 can be equipped with a damping device in a known manner.

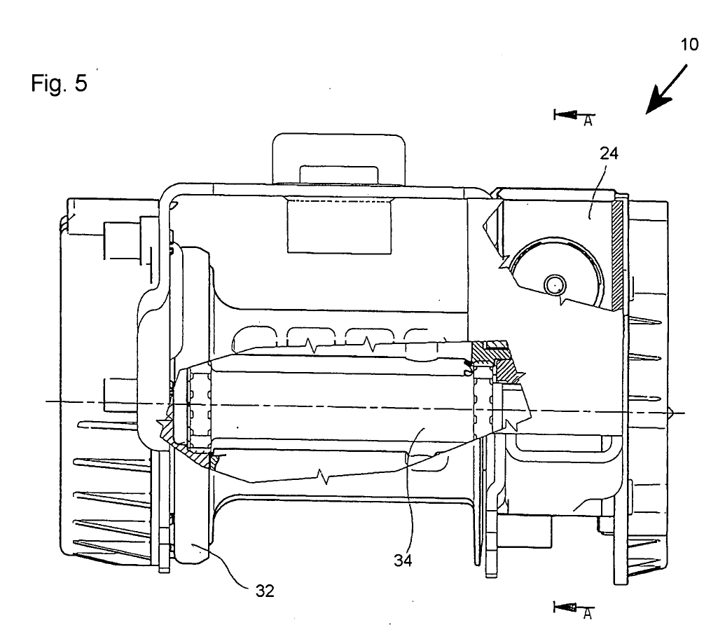

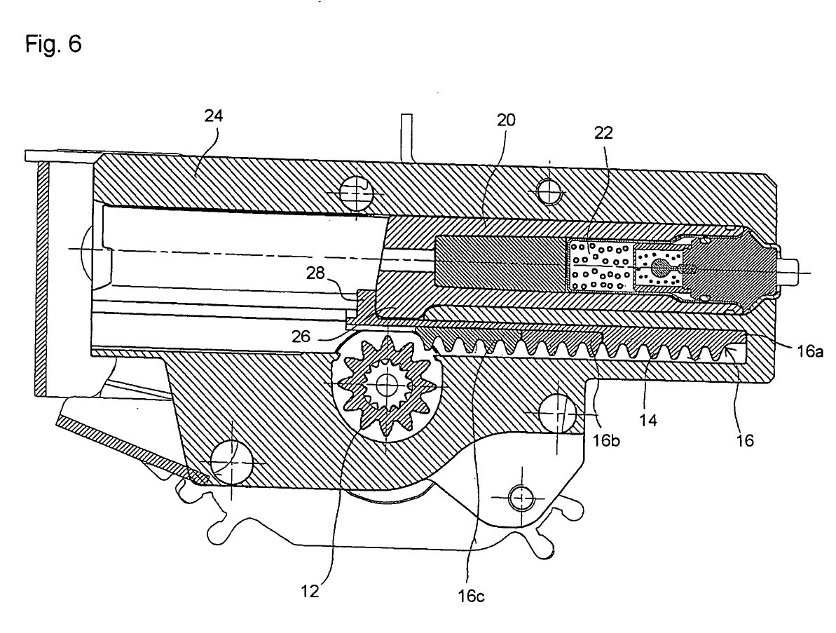

FIGS. 5 and 6 show a further embodiment of the belt tensioner drive according to the present invention. Components already described above have been designated by the same reference numbers.

The embodiment of FIGS. 5 and 6 differs from the embodiment described earlier essentially in that the rack 16 is of a multipart design. A rack base body 16a, which includes the limit stop 28, has two toothed segments 16b, 16c arranged thereon in such a way that they are in contact with an outer tooth, serving as a limit stop, of the segment 16b or of the rack base body 16a. The segments 16b, 16c are attached to the rack base body 16a by riveting, bonding, pressing or the like. This attachment, however, is designed such that the segments 16b, 16c will disengage from the rack base body 16a upon the very first contact with the pinion 12.

Upon activation of the drive 10, the piston 20 moves to the left in accordance with the illustration in FIG. 6. In doing so, the piston 20 entrains the rack base body 16a and the segments 16b, 16c attached thereto, by means of the extension 26 and the limit stop 28. As soon as the segment 16c comes into contact with the pinion 12, the attachment is released. But the segment 16c is still pushed by the rack base body 16a via the segment 16b and drives the pinion 12. When the last tooth of the segment 16c has passed the pinion 12, the segment 16c will fly away to the left due to inertia. The same then goes for the segment 16b.

This multipart structure of the rack 16 has several advantages. Since the segments 16b, 16c can disengage from the rack base body 16a without an impairment of their function, they are no longer a component part of the rack 16 after the tensioning process has been completed. In case a force limitation occurs after the belt tensioning, e.g. by means of the torsion bar 34 of the belt tensioner, shown in FIG. 5, the belt reel 32 and hence the pinion 12 will rotate back. In this reverse rotation of the pinion 12, however, the latter will not come into engagement with the segments 16b, 16c again, so that the piston 20 is not moved back. This rules out a jamming of the piston 20 or of the rack 16 and the belt webbing force will at all events remain below a specified upper limit. Any possible faults in the process of force limitation can be largely excluded in this way.

The rack 16 may also be provided with a rack base body 16a without a toothing and/or with a different number of segments.

1. A drive for a belt tensioner, the drive comprising a housing, a piston that is movably accommodated in the housing, and a rack having a toothing, the rack being arranged outside the housing and having a guide section that is coordinated with a counter guide section that is arranged outside the housing.

2. The drive as recited in claim 1, wherein the counter guide section is configured on the exterior wall of the housing.

3. The drive as recited in claim 1, wherein the guide section is profiled.

4. The drive as recited in claim 1, wherein the guide section is provided on the side of the rack that is opposite the toothing.

5. The drive as recited in claim 1, wherein the rack is designed so as to be spatially separate from the piston.

6. The drive as recited in claim 1, wherein the piston has an extension, which engages a limit stop of the rack.

7. The drive as recited in claim 1, wherein the piston and the rack are rigidly connected to each other.

8. The drive as recited in claim 1, wherein the piston and the rack are connected to each other via a joint.

9. The drive as recited in claim 1, wherein the rack has at least one segment that is releasably attached to a rack base body.

10. The drive as recited in claim 9, wherein the segment is riveted, bonded or pressed onto the rack base body.

11. The drive as recited in claim 9, wherein the segment is attached to and arranged on the rack base body such that after a release of the segment, the latter is entrained only in the driving direction upon a movement of the piston.

12. The drive as recited in claim 11, wherein the segment contacts a limit stop of the rack base body.
